(19) United States
(12) Patent Application Publication
(10) Pub. No.: US 2016/0375919 A1
(43) Pub. Date: Dec. 29, 2016

(54) Litter Box Lifting System

(71) Applicant: Patricia Wright, Delray Beach, FL (US)

(72) Inventor: Patricia Wright, Delray Beach, FL (US)

(21) Appl. No.: 14/751,366

(22) Filed: Jun. 26, 2015

(51) Int. Cl. B62B 3/02; A01K 1/01

(52) U.S. Cl. CPC B62B 3/02; A01K 1/0107

(57) ABSTRACT

A litter box lifting system includes a litter box. A cart is provided that has a base and a platform and the litter box is positioned on the platform. The platform is positionable in a raised position with respect to the base such that the litter box is elevated. Thus, the litter box is accessible to a user without having the user bend over. The platform is positionable in a lowered position with respect to the base such that the litter box is lowered. Thus, the litter box is accessible to an animal. A lifting unit is coupled to the cart and the lifting unit selectively urges the platform between the raised position and the lowered position. A plurality of wheels is provided. Each of the wheels is rotatably coupled to the base such that each of the wheels may roll along a support surface. A handle is attached to the base such the handle may be manipulated thereby facilitating the cart to be rolled along the support surface.

### BACKGROUND OF THE DISCLOSURE

### Field of the Disclosure

The disclosure relates to lifting devices and more particularly pertains to a new lifting device for lifting and lowering a litter box.

### SUMMARY OF THE DISCLOSURE

An embodiment of the disclosure meets the needs presented above by generally comprising a litter box. A cart is provided that has a base and a platform and the litter box is positioned on the platform. The platform is positionable in a raised position with respect to the base such that the litter box is elevated. Thus, the litter box is accessible to a user without having the user bend over. The platform is positionable in a lowered position with respect to the base such that the litter box is lowered. Thus, the litter box is accessible to an animal. A lifting unit is coupled to the cart and the lifting unit selectively urges the platform between the raised position and the lowered position. A plurality of wheels is provided. Each of the wheels is rotatably coupled to the base such that each of the wheels may roll along a support surface. A handle is attached to the base such the handle may be manipulated thereby facilitating the cart to be rolled along the support surface.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a perspective view of a litter box lifting system according to an embodiment of the disclosure.

FIG. 2 is a left side view of an embodiment of the disclosure.

FIG. 3 is a bottom view of an embodiment of the disclosure.

FIG. 4 is a cross sectional view taken along line 4-4 of FIG. 1 of an embodiment of the disclosure.

FIG. 5 is a perspective in-use view of an embodiment of the disclosure.

### DESCRIPTION OF THE PREFERRED EMBODIMENT

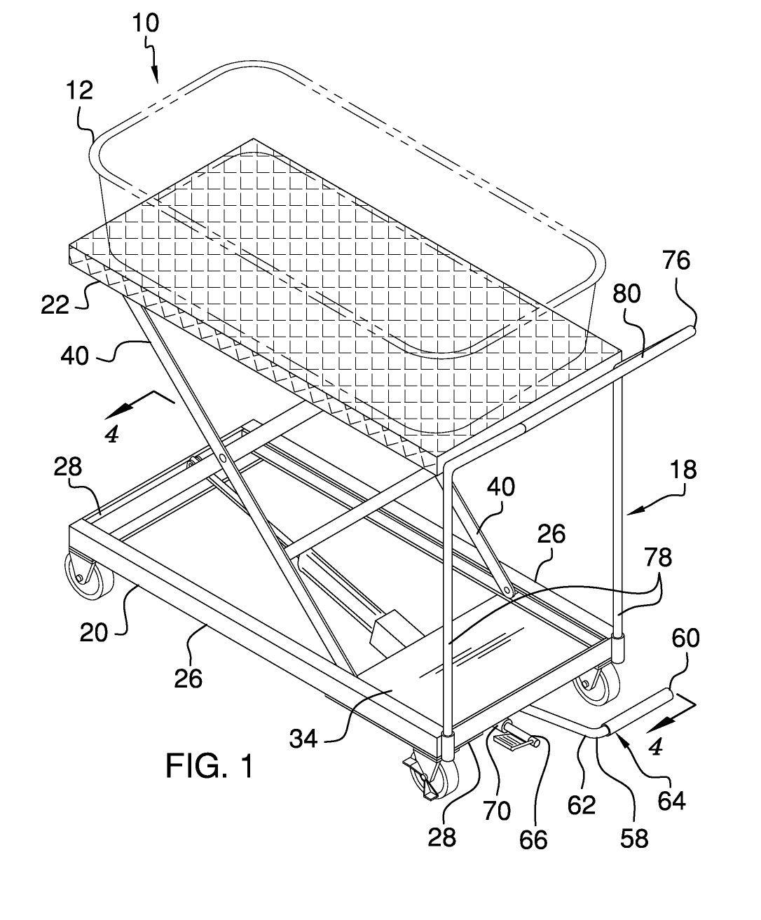

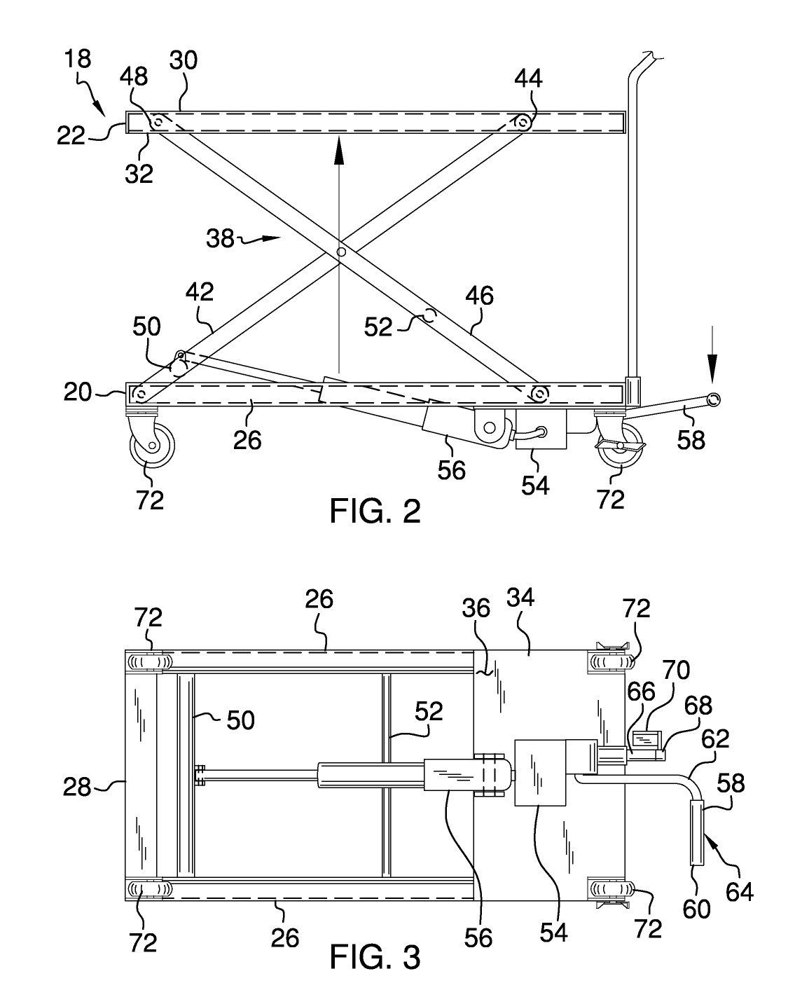

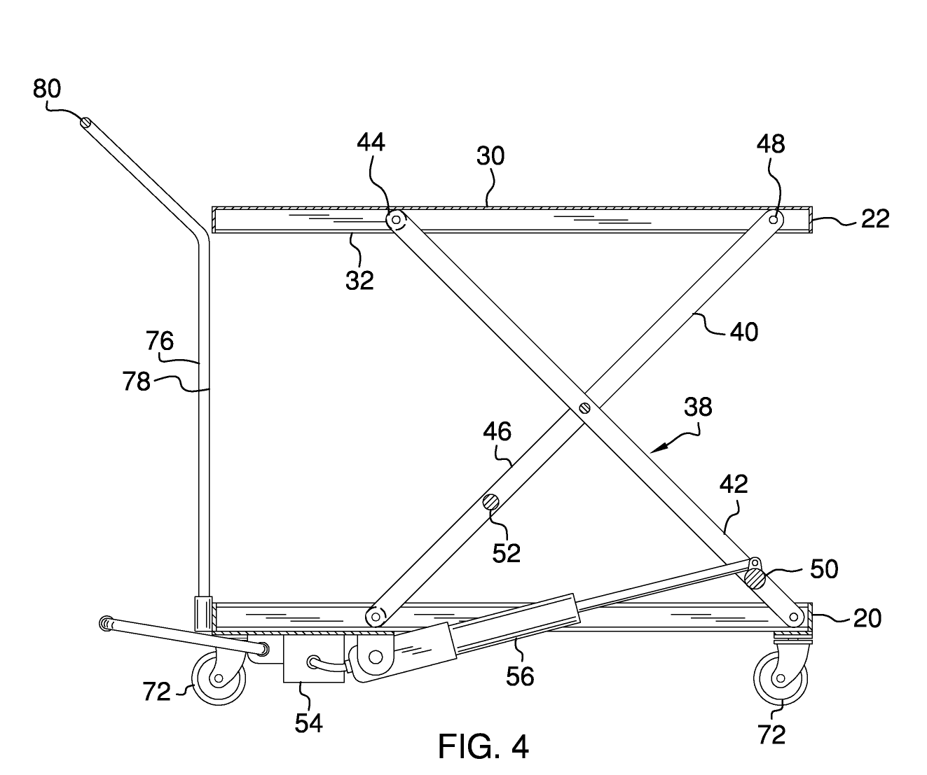

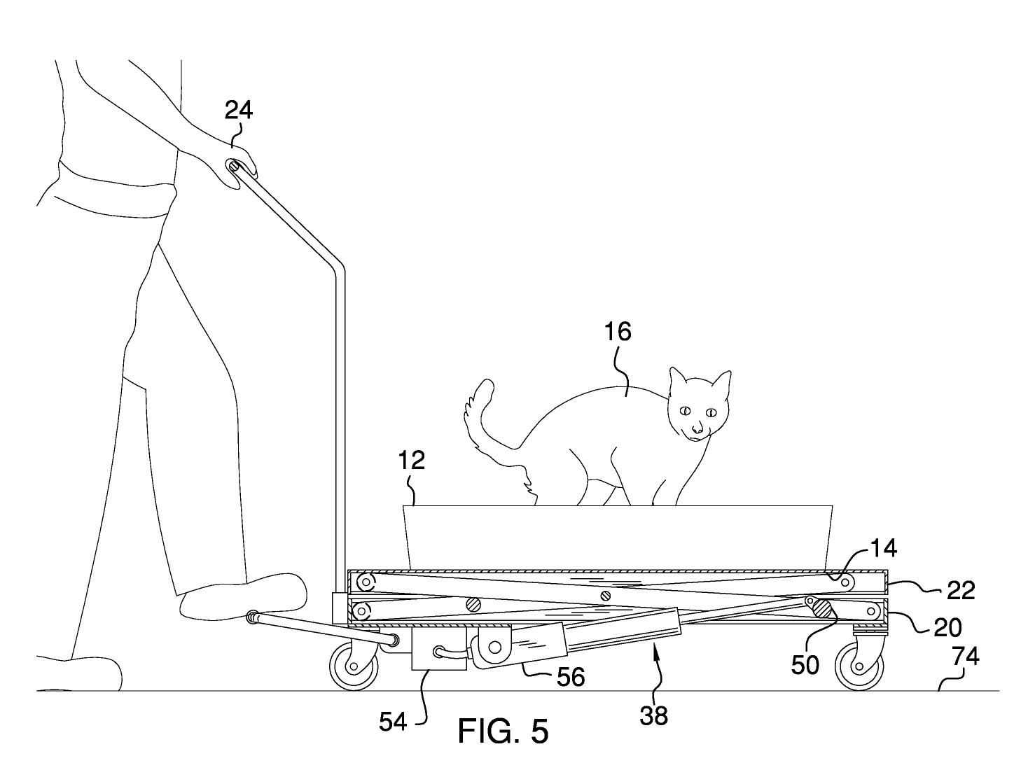

With reference now to the drawings, and in particular to FIGS. 1 through 5 thereof, a new lifting device embodying the principles and concepts of an embodiment of the disclosure and generally designated by the reference numeral 10 will be described.

As best illustrated in FIGS. 1 through 5, the litter box lifting system 10 generally comprises a litter box 12 that has a lower wall 14. The litter box 12 may be a litter box utilized to collect excrement from an animal 16 and the animal 16 may be a common house cat. A cart 18 is provided that has a base 20 and a platform 22 and the litter box 12 is positioned on the platform 22. The platform 22 is positionable in a raised position with respect to the base 20 such that the litter box 12 is elevated. Thus, the litter box 12 is accessible to a user 24 without requiring the user 24 to bend over. The platform 22 is positionable in a lowered position with respect to the base 20 such that the litter box 12 is lowered. Thus, the litter box 12 is accessible to the animal 16.

The base 20 comprises a pair of first arms 26 each coupled between a pair of second arms 28. The first arms 26 are spaced apart from each other such that the base 20 has a rectangular shape. The platform 22 has a top side 30 and a bottom side 32 and the lower wall 14 of the litter box 12 is positioned to abut the top side 30 of the platform 22. A panel 34 is coupled to the base 20 and the panel 34 extends between the first arms 26. The panel 34 abuts one of the second arms 28 and the panel 34 has a lower surface 36.

A lifting unit 38 is coupled to the cart 18 and the lifting unit 38 selectively urges the platform 22 between the raised position and the lowered position. The lifting unit 38 includes a pair of scissor lifts 40. Each of the scissor lifts 40 comprises a first member 42 that is rotatably attached to the base 20. The first member 42 has a distal end 44 with respect to the base 20 and the distal end 44 is rollably coupled to the bottom side 32 of the platform 22 such that the first member 42 travels freely along the bottom side 32.

A second member 46 is rollably attached to the base 20 such that the second member 46 travels freely along the base 20. The second member 46 has a distal end 48 with respect to the base 20 and the distal end 48 of the second member 46 is rotatably coupled to the bottom side 32 of the platform 22. The second member 46 is rotatably coupled to the first member 42 such that each of the scissor lifts 40 forms an X-shape when the platform 22 is positioned in the raised position. Each of the scissor lifts 40 extends between an associated one of the first arms 26 and the platform 22.

A lift rod 50 extends between the first member 42 of each of the scissor lifts 40 and the lift rod 50 is positioned closer to the base 20 than the platform 22. A support rod 52 extends between the second member 46 of each of the scissor lifts 40 and the support rod 52 is positioned closer to the base 20 than the platform 22. The support rod 52 retains each of the scissor lifts 40 to be oriented parallel with each other.

A pump 54 is coupled to the lower surface 36 of the panel 34 and the pump 54 may be a fluid pump or the like. An actuator 56 is attached between the lower surface 36 and the lift rod 50. The actuator 56 is fluidly coupled to the pump 54 such that the pump 54 selectively extends and retracts the actuator 56. The actuator 56 may be a hydraulic cylinder or the like.

A lift lever 58 is attached to the pump 54 and the lift lever 58 has a distal end 60 with respect to the pump 54. The lift lever 58 has a bend 62 thereon and the bend 62 is positioned between the pump 54 and the distal end 60 of the lift lever 58 to define an engaging portion 64 of the lift lever 58. The engaging portion 64 may be urged downwardly such that the pump 54 extends the actuator 56 thereby facilitating the platform 22 to be positioned in the raised position.

A lower lever 66 is attached to the pump 54 and the lower lever 66 has a distal end 68 with respect to the pump 54. The lower lever 66 has a plate 70 extending outwardly from the lower lever 66. The plate 70 is positioned adjacent to the distal end 68 of the lower lever 66. The plate 70 may be manipulated such that the pump 54 retracts the actuator 56 thereby facilitating the platform 22 to be positioned in the lowered position.

A plurality of wheels 72 is provided and each of the wheels 72 is rotatably coupled to the base 20. Thus, each of the wheels 72 may roll along a support surface 74. Each of the wheels 72 is positioned at an associated intersection of the first arms 26 and the second arms 28. A handle 76 is attached to the base 20 such that the handle 76 may be manipulated thereby facilitating the cart 18 to be rolled along the support surface 74. The handle 76 has a pair of longitudinal member 78 each coupled to lateral member 80 and each of the longitudinal members 78 is spaced from each other. Each of the longitudinal members 78 extends upwardly from an associated one of the second arms 28 such that the lateral member 80 is spaced from the associated second arm 28.

In use, the cart 18 is rolled to a desired location and the platform 22 is positioned in the lowered position. The animal 16 utilizes the litter box 12 while the platform 22 is in the lowered position. The lift lever 58 is manipulated to position the platform 22 in the raised position thereby facilitating the litter box 12 to be cleaned or otherwise serviced. The lower lever 66 is manipulated when the litter box 12 has been cleaned or otherwise service thereby facilitating the animal 18 to continue utilizing the litter box 12.

With respect to the above description then, it is to be realized that the optimum dimensional relationships for the parts of an embodiment enabled by the disclosure, to include variations in size, materials, shape, form, function and manner of operation, system and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A litter box lifting system comprising:
a litter box;
a cart having a base and a platform, said litter box being positioned on said platform, said platform being positionable in a raised position with respect to said base such that said litter box is elevated wherein said litter box is configured to be accessible to a user without having the user bend over, said platform being positionable in a lowered position with respect to said base such that said litter box is lowered wherein said litter box is configured to be accessible to an animal;
a lifting unit being coupled to said cart, said lifting unit selectively urging said platform between said raised position and said lowered position;
a plurality of wheels, each of said wheels being rotatably coupled to said base wherein each of said wheels is configured to roll along a support surface; and
a handle being attached to said base wherein said handle is configured to be manipulated thereby facilitating said cart to be rolled along the support surface.

2. The system according to claim 1, wherein:
said base comprises a pair of first arms each coupled between a pair of second arms, said first arms being spaced apart from each other such that said base has a rectangular shape; and
said platform had a top side and a bottom side, said lower wall of said litter box being positioned to abut said top side of said platform.

3. The system according to claim 2, wherein a panel being coupled to said base, said panel extending between said first arms, said panel abutting one of said second arms, said panel having a lower surface.

4. The system according to claim 1, wherein:
said platform has a bottom side;
said base has a pair of first arms; and
said lifting unit comprises a pair of scissor lifts, each of said scissor lifts comprising:
a first member being rotatably attached to said base, said first member having a distal end with respect to said base, said distal end being rollably coupled to said bottom side of said platform such that said first member travels freely along said bottom side; and
a second member being rollably attached to said base such that said second member travels freely along said base, said second member having a distal end with respect to said base, said distal end of said second member being rotatably coupled to said bottom side of said platform, said second member being rotatably coupled to said first member such that each of said scissor lifts forms an X-shape when said platform is positioned in said raised position, each of said scissor lifts extending between an associated one of said first arms and said platform.

5. The system according to claim 4, wherein said lifting unit further comprises:
a lift rod extending between said first member of each of said scissor lifts, said lift rod being positioned closer to said base than said platform; and
a support rod extending between said second member of each of said scissor lifts, said support rod being positioned closer to said base than said platform, said support rod retaining each of said scissor lifts to be oriented parallel with each other.

6. The system according to claim 5, wherein said lifting unit further comprises:
a panel having a lower surface;
a pump being coupled to said lower surface of said panel; and
an actuator being attached between said lower surface and said lift rod, said actuator being fluidly coupled to said pump such that said pump selectively extends and retracts said actuator.

7. The system according to claim 6, wherein said lifting unit further comprises a lift lever being attached to said pump, said lift lever having a distal end with respect to said pump, said lift lever having a bend thereon, said bend being positioned between said pump and said distal end of said lift lever to define an engaging portion of said lift lever, said engaging portion being configured to be urged downwardly such that said pump extends said actuator thereby facilitating said platform to be positioned in said raised position.

8. The system according to claim 6, wherein said lifting unit further comprises a lower lever being attached to said pump, said lower lever having a distal end with respect to said pump, said lower lever having a plate extending outwardly from said lower lever, said plate being positioned adjacent to said distal end of said lower lever wherein said plate is configured to be manipulated such that said pump retracts said actuator thereby facilitating said platform to be positioned in said lowered position.

9. The system according to claim 1, wherein:
said base includes a pair of first arms and a pair of second arms; and
each of said wheels being positioned at an associated intersection of said first arms and said second arms.

10. The system according to claim 1, wherein:
said base includes a pair of second arms; and
said handle having a pair of longitudinal member each being coupled to lateral member, each of said longitudinal members being spaced from each other, each of said longitudinal members extending upwardly from an associated one of said second arms such that said lateral member is spaced from said associated second arm.

11. A litter box lifting system comprising:
a litter box having a lower wall;
a cart having a base and a platform, said litter box being positioned on said platform, said platform being positionable in a raised position with respect to said base such that said litter box is elevated wherein said litter box is configured to be accessible to a user without having the user bend over, said platform being positionable in a lowered position with respect to said base such that said litter box is lowered wherein said litter box is configured to be accessible to an animal, said base comprising a pair of first arms each coupled between a pair of second arms, said first arms being spaced apart from each other such that said base has a rectangular shape, said platform having a top side and a bottom side, said lower wall of said litter box being positioned to abut said top side of said platform;
a panel being coupled to said base, said panel extending between said first arms, said panel abutting one of said second arms, said panel having a lower surface;
a lifting unit being coupled to said cart, said lifting unit selectively urging said platform between said raised position and said lowered position, said lifting unit comprising:
a pair of scissor lifts, each of said scissor lifts comprising:
a first member being rotatably attached to said base, said first member having a distal end with respect to said base, said distal end being rollably coupled to said bottom side of said platform such that said first member travels freely along said bottom side,
a second member being rollably attached to said base such that said second member travels freely along said base, said second member having a distal end with respect to said base, said distal end of said second member being rotatably coupled to said bottom side of said platform, said second member being rotatably coupled to said first member such that each of said scissor lifts forms an X-shape when said platform is positioned in said raised position, each of said scissor lifts extending between an associated one of said first arms and said platform,
a lift rod extending between said first member of each of said scissor lifts, said lift rod being positioned closer to said base than said platform, and
a support rod extending between said second member of each of said scissor lifts, said support rod being positioned closer to said base than said platform, said support rod retaining each of said scissor lifts to be oriented parallel with each other;
a pump being coupled to said lower surface of said panel,
an actuator being attached between said lower surface and said lift rod, said actuator being fluidly coupled to said pump such that said pump selectively extends and retracts said actuator,
a lift lever being attached to said pump, said lift lever having a distal end with respect to said pump, said lift lever having a bend thereon, said bend being positioned between said pump and said distal end of said lift lever to define an engaging portion of said lift lever, said engaging portion being configured to be urged downwardly such that said pump extends said actuator thereby facilitating said platform to be positioned in said raised position, and
a lower lever being attached to said pump, said lower lever having a distal end with respect to said pump, said lower lever having a plate extending outwardly from said lower lever, said plate being positioned adjacent to said distal end of said lower lever wherein said plate is configured to be manipulated such that said pump retracts said actuator thereby facilitating said platform to be positioned in said lowered position;
a plurality of wheels, each of said wheels being rotatably coupled to said base wherein each of said wheels is configured to roll along a support surface, each of said wheels being positioned at an associated intersection of said first arms and said second arms; and
a handle being attached to said base wherein said handle is configured to be manipulated thereby facilitating said cart to be rolled along the support surface, said handle having a pair of longitudinal member each being coupled to lateral member, each of said longitudinal members being spaced from each other, each of said longitudinal members extending upwardly from an associated one of said second arms such that said lateral member is spaced from said associated second arm.
